(19) United States
(12) Patent Application Publication
(10) Pub. No.: US 2012/0111282 A1
(43) Pub. Date: May 10, 2012

(54) HYBRID GROOMING TOOL

(75) Inventor: Edward P. Dennis, Conifer, CO (US)

(73) Assignee: TOPET (H.K.) CO., LIMITED, Kowloon (HK)

(21) Appl. No.: 13/306,779

(22) Filed: Nov. 29, 2011

Related U.S. Application Data
(63) Continuation-in-part of application No. 12/793,506, filed on Jun. 3, 2010.

(51) Int. Cl. A01K 13/00

(52) U.S. Cl. 119/601; 119/611

(57) ABSTRACT

A hybrid grooming tool adapted for use in grooming a furred animal. The hybrid grooming tool includes a plurality of de-shedding blades deposed with respect to a plurality of grooming teeth. The blades include blade edges that, when the hybrid grooming tool is moved with respect to a furred animal, may pass through the fur along with the grooming teeth such that the de-shedding blades pass through matted portions of the fur. As such, the de-shedding blades may cut the matted portions to assist in the removal or untangling of the matted portions of fur. As such, the hybrid grooming tool may be utilized even on matted fur without the need to use another tool to first remove matted portions of fur from the coat of the furred animal.

### RELATED APPLICATIONS

This application claims priority as a continuation-in-part under 35 U.S.C. §120 to U.S. application Ser. No. 12/793,506 filed Jun. 3, 2010 entitled “UNDERCOAT RAKE FOR GROOMING A FURRED ANIMAL”, the entirety of which is incorporated by reference herein.

### FIELD

The present disclosure relates to a hybrid grooming tool for use in the grooming of a furred animal, such as a dog. In particular, the disclosure is directed to a grooming tool that includes a plurality of grooming teeth and a plurality of de-shedding blades extending from the grooming tool for use in grooming the furred animal.

### BACKGROUND

Grooming an animal is important to the animal's health and appearance. Grooming can also provide enjoyment to the groomer, which in many cases is the owner of the animal. Grooming may also allow for emotional bonding between the animal and groomer. Accordingly, there exists a need for products and apparatus in order to assist an owner or groomer in the grooming of an animal.

Some animals have a coat of fur that includes an undercoat and a topcoat. For example, many dog breeds have a topcoat and an undercoat. Generally, the topcoat includes rough, somewhat weather resistant fur that functions to repel water, wind, and other dirt or debris. The undercoat usually comprises thick, warm, down-like fur made up of generally shorter hairs than those of the topcoat. The undercoat fur is usually dense enough to resist penetration of water to the skin of the animal and provides an insulating layer to assist in keeping the animal warm. As such, many animals, and particularly dogs, seasonally grow a dense undercoat. In turn, the undercoat may also be seasonally shed.

Shedding occurs when each follicle of hair in an animal's coat follows a cycle of growing, dying, and being replaced by another follicle. When the follicle dies, the hair becomes detached, or shed. This shedding process may occur constantly. The rate at which fur is shed may be affected by such factors as the breed, age and environment of the animal. For instance, as stated above, the undercoat of the animal may change seasonally, such that in cooler months of the year the undercoat grows denser in order to provide insulation. Accordingly, during warmer months, a portion of the undercoat may be shed.

While shedding of the undercoat occurs naturally, it may be advantageous to assist in the removal of the undercoat by grooming the animal. For instance, if a dog is kept indoors, the owner may wish to assist or accelerate the shedding process by brushing or combing the fur of the dog in order to remove loose fur or fur that will soon be shed. The grooming of a dog to remove the undercoat may be conducted in a location determined by the owner. The location of grooming may be controlled such that the grooming process is conducted to prevent continuous shedding within the owner's home or other location where shedding might be undesirable. Shedding can thus be controlled such that the owner may be able to selectively groom the dog in order to help prevent the undercoat from being shed indoors.

Preventing an animal from shedding indoors presents several advantages versus allowing natural shedding. For many individuals, loose fur of the animal may be an allergen such that limiting the amount of fur shed indoors may prevent unwanted allergy symptoms. Further, fur that has been shed may cling to upholstery or clothing and may require much time and effort to remove the fur from such surfaces.

Additionally, assisting in the normal process of shedding through grooming may benefit the health and comfort of the animal. An excessive amount of residual undercoat may cause the animal to endure heat stress more readily due to the insulating properties of the undercoat. Grooming may also calm or relax the animal.

Moreover, grooming and undercoat removal may prevent the animal's fur from becoming tangled or matted. Many furred animals, especially those with longer coats, may develop tangled portions of fur that may result in the fur becoming matted. Matted fur may be painful to the animal as the matted fur may pull living hair from the skin of the animal. Furthermore, the presence of matted fur may lead to the animal developing hotspots or other problematic skin conditions.

Matted fur may be difficult to remove and may hinder the normal grooming of a furred animal. For example, when attempting to remove the undercoat or otherwise brush a furred animal, portions of matted or tangled fur may obstruct the grooming tool from passing through the fur of the animal. It may be necessary to employ a separate tool (e.g., scissors, clippers, etc.) to remove the matted portion of the fur to continue to perform the grooming of the dog. For severely matted fur, the removal of the matted portions of fur may be extremely time consuming, tedious, and may be painful to the animal. For example, fur may become so matted that attempts to comb out the matted fur only results in the fur surrounding the matted fur to be painfully pulled from the animal. As such, often times such matted portions of fur must cut out of the coat of the furred animal (e.g., using scissors, etc.). Accordingly, the possibility that the animal or groomer may be lacerated when removing the matted portion is increased. Many times, home groomers cannot adequately remove matted portions of fur and must rely on costly professional grooming. In still other instances, simply removing all or a portion of the animal's coat is the only feasible option, which may leave the animal susceptible to environmental conditions, such as wet or cold, or may detract from the physical appearance of the animal.

### SUMMARY

There exists a need for tools that are adapted to efficiently thin the undercoat of a furred animal in order to prevent unwanted or uncontrolled shedding that simultaneously address matted or tangled portions of the animal's coat. Accordingly, a hybrid grooming tool for grooming a furred animal, including the removal of undercoat fur that has been shed or is soon to be shed while simultaneously addressing matted or tangled portions of hair is provided. The hybrid grooming tool disclosed herein may provide for effective undercoat removal when used in grooming. The hybrid grooming tool may provide a safe, simple to use, and effective way to groom a furred animal, even if the furred animal has matted or tangled fur.

A first aspect includes a hybrid grooming tool for grooming a furred animal. The hybrid grooming tool includes a tool body, a plurality of grooming teeth operatively affixed to and extending from the tool body, and a plurality of de-shedding blades operatively affixed to and extending from the tool body. The tool body is disposable adjacent to fur of the furred animal such that the plurality of grooming teeth and the plurality of de-shedding blades are both disposed within the fur of the furred animal.

A second aspect includes a hybrid grooming tool for grooming a furred animal. The hybrid grooming tool includes a tool body having a head portion having a length along a major axis of the head portion and a handle portion having a longitudinal axis. The major axis is substantially perpendicular to the longitudinal axis. The hybrid grooming tool also includes a plurality of grooming teeth operatively affixed to the head portion in a first row. The grooming teeth include a plurality of first teeth and a plurality of second teeth, each having a base portion adjacent to and extending from the tool body, a tip portion at a distal end, and a shoulder disposed between the base portion and the tip portion such that the length of the tip portion of the first teeth is greater than the length of the tip portion of the second teeth. The hybrid grooming tool also includes a plurality of de-shedding blades operatively affixed to the head portion in a second row and extending therefrom in substantially the same direction from the head portion as the plurality of grooming teeth. A blade edge of the de-shedding blades is offset from the grooming teeth with respect to a direction corresponding to the longitudinal axis of the handle portion.

A third aspect includes a method for grooming a furred animal, the method includes providing a hybrid grooming tool according to any of the aspect or embodiments. The method further includes positioning the hybrid grooming tool adjacent to the furred animal such that the grooming teeth and de-shedding blades engage fur of the furred animal. The method also includes moving the hybrid grooming tool with respect to the furred animal while maintaining engagement of the grooming teeth and de-shedding blades with the fur such that the grooming teeth act upon the fur passing therebetween to remove loose hairs therefrom and the de-shedding blades (i.e., the blade edges thereof) cut through matted fur contacting the de-shedding blades as the hybrid grooming tool is moved with respect to the animal, thus grooming the animal. For example, the blade edges of the de-shedding blades may cut through matted fur prior to the grooming teeth passing through the matted fur as the hybrid grooming tool is moved with respect to the animal.

A number of feature refinements and additional features may be applicable to any one or more of the foregoing aspects. These feature refinements and additional features may be used individually or in any combination. As such, each of the following features that will be discussed may be, but are not required to be, used with any other feature or combination of features of any or all of the foregoing aspects.

For example, in one embodiment, the plurality of grooming teeth and the plurality of de-shedding blades may extend in substantially the same direction from the tool body. Additionally, the plurality of de-shedding blades may be safety blades. The safety blades may include dull distal end portions of a blade edge. As such, the likelihood of inadvertent contact (i.e., with the skin of the animal or groomer) with the blade edge may be reduced.

In another embodiment, the tool body may have at least a head portion having a length along a major axis of the head portion. The grooming teeth may be affixed to the tool body along the length of the head portion in a first row, and the de-shedding blades may be affixed to the tool body along the length of the head portion in a second row. The grooming teeth may be offset from the blade edges of the de-shedding blades by a distance perpendicular to the major axis of the head portion. For example, the grooming teeth may be offset from the blade edges by at least about ______ mm and not greater than about ______ mm.

In another embodiment, the grooming teeth may comprise a plurality of first teeth and a plurality of second teeth. The first teeth may have a base portion adjacent to and extending from the tool body, a tip portion at a distal end, and a shoulder disposed between the base portion and the tip portion, and the second teeth having a base portion adjacent to and extending from the tool body, a tip portion at a distal end, and a shoulder disposed between the base portion and the tip portion. The length of the tip portion of the first teeth may be greater than the length of the tip portion of the second teeth. The first teeth and the second teeth may be alternately disposed along at least a portion of the length of the head portion.

In another embodiment, at least one of the plurality of de-shedding blades may be disposed, with respect to the length along the major axis of the head portion, between adjacent grooming teeth. The first teeth and the second teeth may alternate at adjacent tooth positions along at least a portion of the length of the head portion. Adjacent grooming teeth may be spaced apart by at least about 2 mm and not greater than about 6 mm. Alternatively or additionally, at least one of the second teeth may be disposed adjacent to two of the first teeth.

In one embodiment, the total length of the first teeth and the total length of the second teeth may be substantially the same. For instance, the total length of the first teeth and the total length of the second teeth may be at least about 10 mm and not greater than about 40 mm. Alternatively, the total length of the first teeth and the total length of the second teeth may be different. The tip portion of the first teeth may be at least 15% longer than the tip portion of the second teeth. In this regard, the length of the tip portion of the first teeth may be at least about 5 mm and the length of the tip portion of the second teeth may not greater than about 30 mm. The base portions of the grooming teeth may have a cross dimension that may be at least about 2 mm and not greater than about 6 mm. The tip portion of the grooming teeth may have a cross dimension that may be at least about 0.5 mm and not greater than about 4 mm.

In one embodiment, the grooming teeth may be substantially rigid. In this regard, the grooming teeth may be metallic. For example, the grooming teeth may be stainless steel. Similarly, the de-shedding blades may be metallic such as, for example, stainless steel.

In yet another embodiment, the tool body may further include a handle portion that may be adapted to be gripped by a user. The major axis of the head portion may be substantially perpendicular to a longitudinal axis of the handle portion. The handle portion may extend from the head portion in a direction corresponding to a direction of travel of the hybrid grooming tool with respect to the furred animal. A blade edge of the plurality of de-shedding blades may be positioned upstream with respect to the plurality of grooming teeth in the direction of travel of the hybrid grooming tool with respect to the furred animal. For example, the blade edges may be provided on the de-shedding blades opposite the grooming teeth with respect to the direction of travel of the hybrid grooming tool with respect to the furred animal.

In still another embodiment, the de-shedding blades may extend away from the tool body for a portion of the distance which the plurality of grooming teeth extend from the tool body. For example, the de-shedding blades may extend about for about ______ % of the distance the grooming teeth extend from the tool body. Alternatively, the de-shedding blades extend for substantially the same distance from the tool body as the plurality of grooming teeth.

The embodiments presented are advantageous because it has been found that the provision of de-shedding blades with respect to the grooming teeth of a grooming tool allows the grooming tool to pass through matted fur so as to quickly, efficiently, and safely groom an animal with matted fur with a single grooming tool. Rather than having to use additional tools to cut through matted portion of fur or to cut out matted portions of fur, the inclusion of de-shedding blades on the grooming tool allows the de-shedding blades to cut through matted portions of fur when the grooming tool is moved with respect to the animal during the normal course of grooming with the grooming tool (e.g., when using the grooming tool to remove shed undercoat fur). Moreover, the shape and arrangement of the grooming teeth have been found to be highly effective to rapidly and efficiently thin the undercoat of a furred animal. The first and second grooming teeth may include base portions and/or tip portions of different lengths such that a combination of first and second grooming teeth form a variable depth grooming profile as the grooming teeth are moved through the animal's fur. As the first and second grooming teeth have different profiles, and simultaneously act upon the animal's fur at different depths, they act in coordination to pull and collect more loose undercoat fur than an undercoat rake having grooming teeth with the same depth profile.

### BRIEF DESCRIPTION OF THE DRAWINGS

FIG. 1 is a perspective view of an embodiment of an undercoat rake.

FIG. 2 is a bottom view of the embodiment of an undercoat rake of FIG. 1.

FIG. 3 is a side view of the embodiment of an undercoat rake of FIG. 1.

FIG. 4 is a front view of the embodiment of an undercoat rake of FIG. 1.

FIG. 5 is a schematic view of adjacent grooming teeth that are useful in an embodiment of an undercoat rake.

FIG. 6 is a front view of another embodiment of an undercoat rake.

FIG. 7 is a schematic view of adjacent grooming teeth that are useful in another embodiment of an undercoat rake.

FIG. 8 is a front view of yet another embodiment of an undercoat rake.

FIG. 9 is a schematic view of adjacent grooming teeth that are useful in yet another embodiment of an undercoat rake.

FIGS. 10A-10C depict various embodiments of a hybrid grooming tool including a plurality of grooming teeth and a plurality of de-shedding blades.

FIGS. 11A-11C are schematic side views of the grooming teeth and de-shedding blades of various embodiments of a hybrid grooming tool.

FIG. 12 is a schematic end view of the grooming teeth and de-shedding blades of an embodiment of a hybrid grooming tool.

FIG. 13 depicts another embodiment of a hybrid grooming tool.

FIG. 14 depicts a detail view of the head portion of the embodiment depicted in FIG. 13.

### DETAILED DESCRIPTION

The following description is not intended to limit the invention to the form disclosed herein. Consequently, variations and modifications commensurate with the following teachings, skill and knowledge of the relevant art, are within the scope of the present invention. The embodiments described herein are further intended to explain modes known of practicing the invention and to enable others skilled in the art to utilize the invention in such, or other embodiments and with various modifications required by the particular applications(s) or use(s) of the present invention.

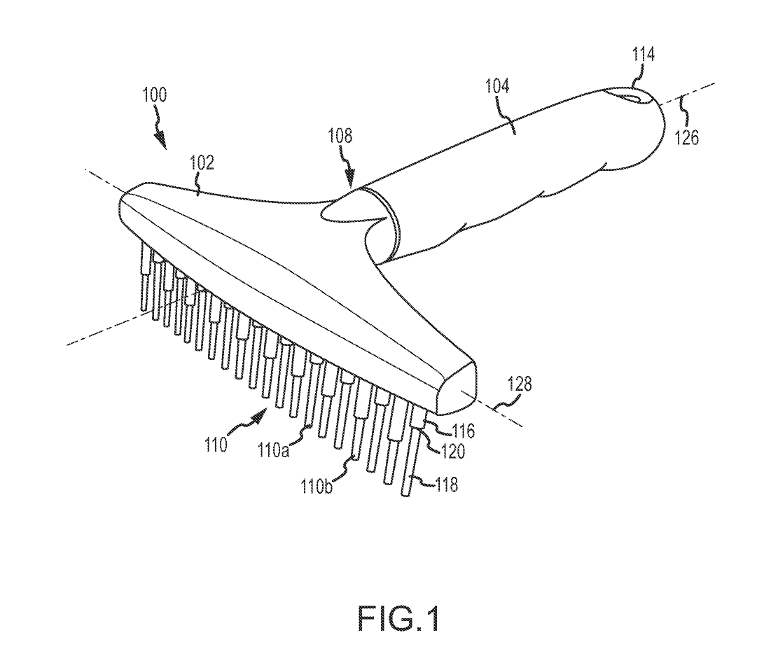

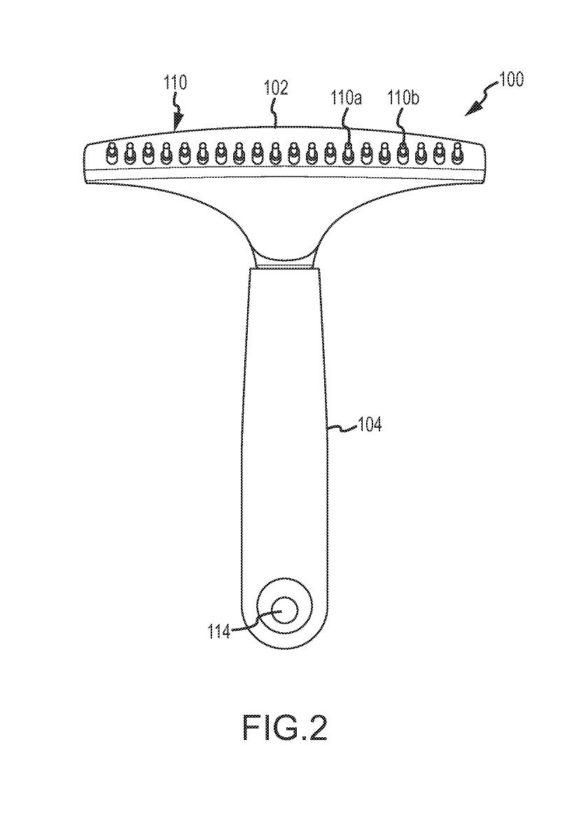

FIGS. 1-4 illustrate an embodiment of an undercoat rake that is adapted for removal of undercoat fur from a furred animal. The undercoat rake 100 may include a rake body 108 that may further include a head portion 102 that may be operatively attached to a handle portion 104. Grooming teeth 110 may include a plurality of first teeth 110a and a plurality of second teeth 110b that may be operatively affixed to and extend from the rake body 108. The first teeth 110a and the second teeth 110b may have a base portion 116 and a tip portion 118 with a shoulder 120 disposed between the base portion 116 and the tip portion 118, where the corresponding base and/or tip portions of first teeth 110a and second teeth 110b may be different lengths. In this regard, first teeth 110a and second teeth 110b may comprise different grooming depth profiles that in combination (e.g., when disposed in an alternating relationships) are advantageous for grooming a furred animal, whereby the different depth profiles of first teeth 110a and second teeth 110b may coordinate to form a varied depth raking profile when moved through the fur of an animal.

The rake body 108 of the undercoat rake 100 may include a head portion 102 and a handle portion 104. The handle portion 104 may include a longitudinal axis 126 along the length of the handle portion 104. The handle portion 104 may be designed so that a user may grip and manipulate the handle portion 104 in order to control the undercoat rake 100 during use (e.g., by varying pressure, angle, depth etc. of the grooming teeth 110 with respect to the animal's fur).

The head portion 102 and the handle portion 104 may be arranged in a variety of ways. For example, the head portion 102 may include a length along a major axis 128 of the head portion 102 and the major axis 128 may be arranged substantially perpendicular to the longitudinal axis 126 of the handle portion 104 to form a “T”-shaped rake body 108 as shown in FIG. 1. Alternatively, a head portion may be arranged such that a major axis may be substantially parallel to a longitudinal axis of a handle portion. In this manner, an undercoat rake may comprise a substantially elongate rake body.

The handle portion 104 may include an aperture 114 for mounting and storing the undercoat rake 100. The head portion 102 and handle portion 104 may be constructed of the same material or different materials. For instance, the head portion 102 may be made of polymer, metal, wood, any other suitable material, or a combination thereof. The handle portion 104 may also be made of polymer, metal, wood, any other suitable material, or a combination thereof.

The undercoat rake 100 may include first teeth 110a and second teeth 110b operatively affixed to the rake body 108. The grooming teeth 110 may be affixed to the undercoat rake 100 such that the grooming teeth 110 may be disposed for engagement with the fur of a furred animal. As such, the grooming teeth 110 can be moved along the body of the furred animal such that the grooming teeth 110 maintain engagement with the fur of the animal to remove of fur that has been or is soon to be shed.

The grooming teeth 110 may be affixed to the head portion 102 such that the grooming teeth 110 may engage the fur of an animal when a user grasps the handle portion 104. The grooming teeth 110 may be arranged along the length of the head portion 102 corresponding to the major axis 128. In one embodiment, the grooming teeth 110 may be arranged in a generally linear fashion along the length of the head portion 102. In an alternative embodiment, grooming teeth may be arranged radially about a head portion along a length thereof. Accordingly, grooming teeth may radiate from a cylindrical head portion such that grooming teeth both extend along and around the cylindrical head portion. Alternatively, grooming teeth may be staggered in various respects along a length of a head portion. In any regard, grooming teeth may be arranged in any fashion that allows for the interaction of grooming teeth with an animal's fur.

The grooming teeth 110 may be constructed of wood, polymer, metal, any other suitable material, or a combination thereof. By suitable material, it is to be understood that the material from which the grooming teeth 110 are constructed may be substantially rigid such that upon movement of the grooming teeth 110 with respect to the fur of the animal there may be substantially no deflection of the grooming teeth 110 along the length of the grooming teeth 110 from the force of the fur acting upon the grooming teeth 110 that would substantially inhibit removal of fur by the grooming teeth 110. In one embodiment, the grooming teeth 110 may be metallic. By way of example, the grooming teeth 110 may be constructed from a rust and corrosion resistant material such as stainless steel. While it is to be understood that the grooming teeth 110 may be constructed so as not to substantially deflect along the length of the grooming teeth 110, the grooming teeth 110 may be affixed to the head portion 102 in a manner than allows for some deflection (e.g., pivoting) of the grooming teeth 110 with respect to the head portion 102. Allowing some small deflection of the grooming teeth 110 with respect to the head portion 102 may prevent the grooming teeth 110 from pulling matted or tangled hair in a manner that may hurt the animal being groomed. For example, grooming teeth may be attached to a resilient rubber pad (e.g., a slicker pad) that is mounted to the head portion, enabling the grooming teeth to pivot slightly with respect to the head portion. However, the grooming teeth 110 should not deflect with respect to the head portion 102 to a degree that substantially hinders fur removal due to the deflection of the grooming teeth 110 with respect to the head portion 102.

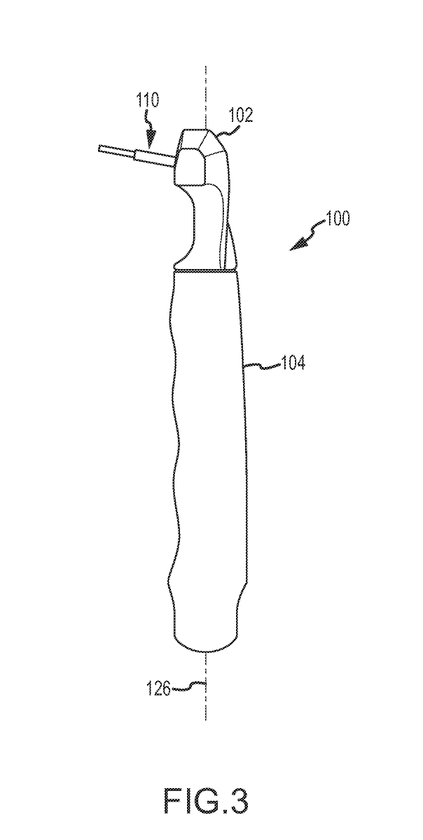

Turning to FIG. 3, a side view of the undercoat rake 100 is shown. As can be appreciated, the grooming teeth 110 may extend away from the head portion 102. The grooming teeth 110 may be slightly angled from a perpendicular orientation in relation to the longitudinal axis 126 of the handle portion 104. For example, as illustrated in FIG. 3, the grooming teeth 110 are disposed at an obtuse angle with respect to the longitudinal axis 126 of the handle portion 104. In any event, the grooming teeth 110 may be disposed so as to be capable of engaging the fur of an animal while a user grasps the handle portion 104 in order to manipulate the undercoat rake 100.

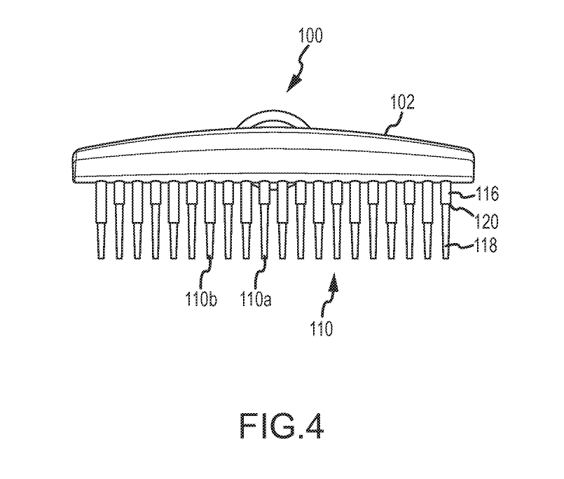

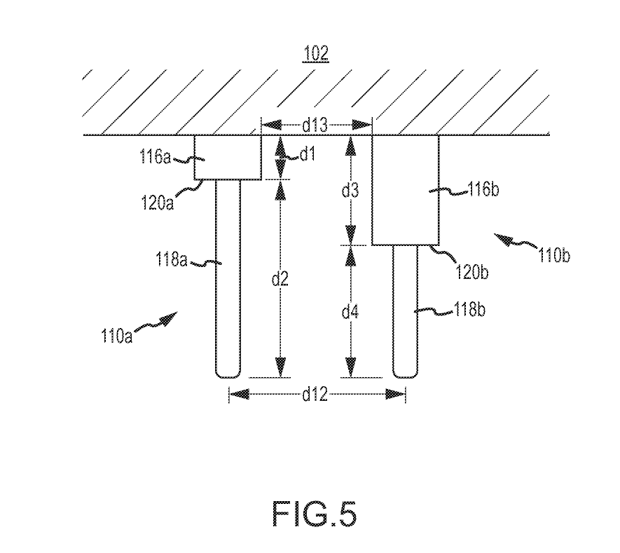

With reference to FIGS. 4 and 5, the grooming teeth 110 may generally include a base portion 116 and a tip portion 118 that may be separated by a shoulder 120. The base portions 116 of the grooming teeth 110 may be adjacent to the head portion 102 and extend therefrom, such that the base portions 116 may comprise a proximate end of the grooming teeth 110. The grooming teeth 110 also may include a tip portion 118 that may be arranged at a distal end (i.e., away from the rake body 108) of the grooming teeth 110. A shoulder 120 may separate the tip portion 118 and the base portion 116 of the grooming teeth 110. As illustrated in FIGS. 4-5, the shoulder 120 comprises an annular step that separates the tip portion 118 from the base portion 116. A shoulder may also comprise, for example, shapes other than an annular step, such as a frustoconical shape between a tip portion and a base portion, for example. In any event, the shoulder 120 may comprise the transition from the base portion 116 to the tip portion 118.

In this regard, the base portion 116 may have a different cross dimension (e.g., diameter) than the tip portion 118. For instance, the tip portion 118 may have a smaller cross dimension than the base portion 116. In one embodiment, the tip portion 118 may have a cross dimension of at least about 30% and not greater than about 70% of a cross dimension of the base portion 116. Additionally, the base portion 116 may have a cross dimension of at least about 2 mm and not greater than about 6 mm. The tip portion 118 may have a cross dimension of at least about 0.5 mm and not greater than about 4 mm. In one embodiment, the base portion 116 and the tip portion 118 may have a circular cross-section and the cross dimension may be equivalent to the diameter of the portions. Other cross-sectional shapes of the tip portion and base portion may be employed, such as, for example, an oval cross-section or a polygonal cross-section.

Referring to FIG. 5, the tip portion 118a of first teeth 110a may be of a different length than the tip portion 118b of second teeth 110b. When the grooming teeth 110 have substantially the same total length, the length of the base portions (e.g., the distance of the shoulder from the head portion) may also be different. The base portion 116a of first teeth 110a may have a length d1 and the tip portion 118a of first teeth 110a may have a length d2. The base portion 116b of second teeth 110b may have a length d3 and the tip portion 118b of second teeth 110b may have a length d4. In this embodiment, d2 may be greater than d4. As such, first teeth 110a may have a longer tip portion 118a than a tip portion 118b of second teeth 110b. Additionally, d1 may be less than d3. In turn, second teeth 110b may have a longer base portion 116b than a base portion 116a of first teeth 110a. In this particular embodiment, first teeth 110a and second teeth 110b may have substantially the same total length.

The grooming teeth 110 should be of sufficient total length to effectively groom a furred animal such as a dog. By way of example, the total length of first teeth 110a and second teeth 110b (e.g., d1+d2) may be at least about 10 mm and not greater than about 40 mm, such as not greater than about 25 mm. To form a variable depth grooming profile, the length d2 of the tip portion 118a of first teeth 110a may be at least about 15% longer than the length d4 of the tip portion 118b of second teeth 110b, such as at least about 30% longer. For example, the length d2 of tip portion 118a may be at least about 5 mm and not greater than about 30 mm and the length d4 of the tip portion 118b may be at least about 4 mm and not greater than about 25 mm, while being less than the length d2 of the tip portion 118a. The length d1 of the base portion 116a may be at least about 4 mm and not greater than about 25 mm and the length d3 of the base portion 116b may be at least about 5 mm and not greater than about 30 mm, while being greater than the length d1 of the base portion 116a.

The grooming teeth 110 should also be spaced sufficiently close together to enable efficient grooming of the furred animal. In this regard, the grooming teeth 110 may be spaced apart from adjacent grooming teeth 110 by a distance d12 as measured between the centers of the tip portions 118. The distance d12 may be substantially the same between all adjacent grooming teeth 110 or the distance d12 may be different for different adjacent grooming teeth 110. By way of example, the distance d12 may be at least about 3 mm and not greater than about 8 mm. Furthermore, the base members 116 may be separated by a distance d13 corresponding to the shortest distance between outer surfaces (e.g., edge to edge) of adjacent base portions. For example, the distance d13 may be at least about 2 mm and not greater than about 5 mm. The distance d13 may be the same between all adjacent base portions 116 or may vary between the outer surfaces of adjacent base portions 116.

In one embodiment, there may be provided grooming teeth in addition to first teeth 110a and second teeth 110b such that additional grooming teeth may be included in the undercoat rake 100. In this regard, if additional grooming teeth are included, the additional grooming teeth may include portions (e.g., base portions and tip portions) corresponding to the portions that were described above regarding first teeth 110a and second teeth 110b. The additional grooming teeth may have corresponding grooming teeth portions with different dimensions (e.g., grooming depth profile) than either first teeth 110a or second teeth 110b, or the additional grooming teeth may share common dimensions with either first teeth 110 or second teeth 110b for some corresponding portions.

In another embodiment, grooming teeth may have different (e.g., fewer or more) portions than the grooming teeth 110 (e.g., a central portion disposed between a base portion and a tip portion and separated from each by a shoulder).

First teeth 110a and second teeth 110b may be disposed along the length of the head portion 102 such that the grooming teeth 110 may be alternately disposed along at least a portion thereof. By alternately disposed, it is meant that first teeth 110a and second teeth 110b may be operatively disposed in any alternating or semi-alternating arrangement along the length of the head portion 102 such that at least one first tooth may be disposed adjacent to at least one second tooth. For instance, as illustrated in FIG. 4, first teeth 110a and second teeth 110b may be alternately disposed along a substantially linear row such that every other grooming tooth along the length of the head portion 102 may be the same, with a differently shaped tooth disposed therebetween. In this regard, the grooming teeth 110 may strictly alternate such that first teeth 110a may alternate with second teeth 110b and each adjacent tooth may be different. Alternatively, first teeth 110a or second teeth 110b may be repeated for a number of grooming teeth positions (e.g., two adjacent positions) such that a first tooth 110a or a second tooth 110b may be adjacent to one or more of the same type of grooming teeth 110. This may result in repeating and/or alternating first teeth 110a and second teeth 110b along the length of the head portion 102. In sum, first teeth 110a and second teeth 110b may be arranged in any pattern or sequence of first teeth 110a and second teeth 110b along the length of the head portion 102 to form a varied depth profile.

The grooming rake 100 may include a total number of grooming teeth 110 generally between 10 and 30 total teeth. In one embodiment, the grooming rake 100 includes a total number of grooming teeth 110 between 15 and 25 total teeth.

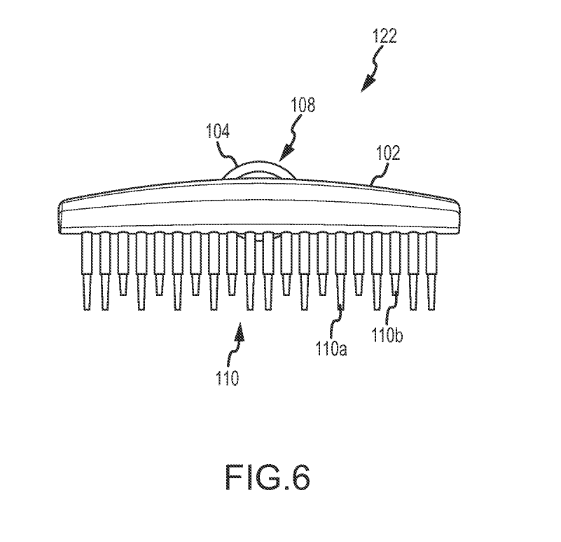

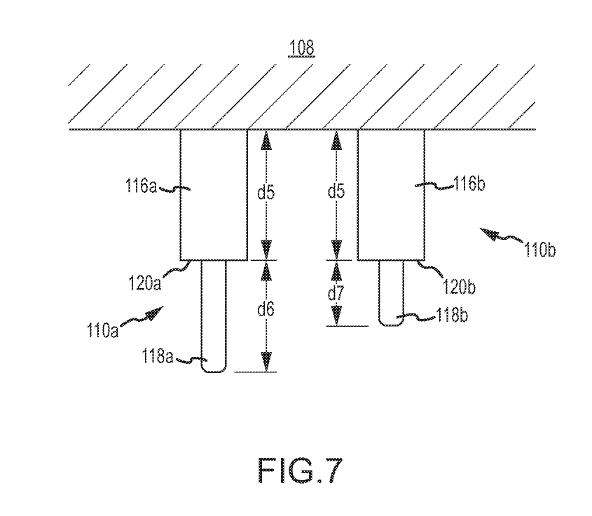

FIGS. 6 and 7 show an alternative embodiment of an undercoat rake 122. The undercoat rake 122 may have a rake body 108 including a handle portion 104 and a head portion 102 similar to the handle portion 104 and head portion 102 referenced and described with respect to FIGS. 1-4. The undercoat rake 122, like the undercoat rake 100, may include a plurality of grooming teeth 110 that project from the rake body 108.

FIG. 7 is a schematic view of first teeth 110a and second teeth 110b that may be useful in the undercoat rake 122. First teeth 110a and second teeth 110b may have a base portion 116 that extends from the head portion 102 and a tip portion 118 at a distal end. The tip portion 118 may be separated from the base portion 116 by a shoulder 120.

In this embodiment, the base portion 116a of first teeth 110a may extend for substantially the same length away from the head portion 102 as the base portion 116b of second teeth 110b. In this regard, both base portions 116 of the grooming teeth 110 may have a length d5. The length d6 of the tip portion 118a of first teeth 110a may be longer than the length d7 of the tip portion 118b of second teeth 110b. The base portions 116 of the grooming teeth 110 may be substantially the same length, while the tip portions 118 may have different lengths. Accordingly, the total lengths (e.g., d5+d6 or d5+d7) of first teeth 110a and second teeth 110b may be different for the undercoat rake 122.

Grooming teeth 110 may be disposed along the length of the head portion 102 such that the grooming teeth 110 are alternately disposed along at least a portion thereof. In this regard, first teeth 110a and second teeth 110b may be intermixed along the length of the head portion 102 as was described with reference to the embodiment of FIGS. 1-5. As such, second teeth 110b may separate pairs of first teeth 110a at certain positions along the length of the head portion 102. However, with reference to the ends of the head portion 102 as shown in FIG. 6, for example, some first teeth 110a may be adjacent. Also, while not shown, some second teeth 110b may be positioned adjacent to one another.

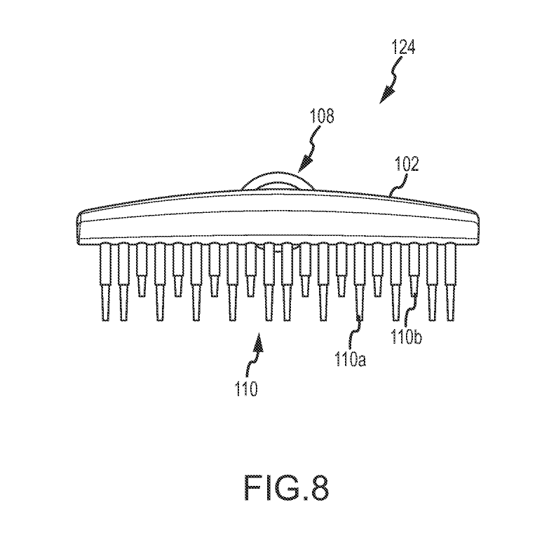

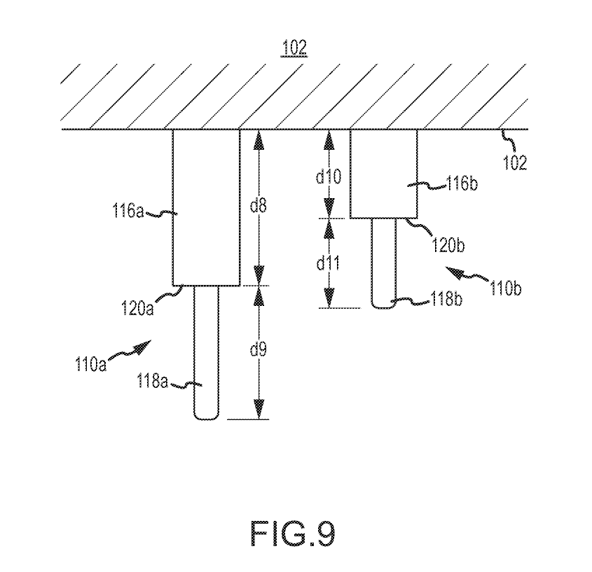

Another alternative embodiment of an undercoat rake 124 is shown in FIGS. 8 and 9. In FIG. 9, first teeth 110a and second teeth 110b of the undercoat rake 124 are shown. First teeth 110a may have a base portion 116a that may extend from the head portion 102 for a length d8. First teeth 110a also may have a tip portion 118a at a distal end that may extend for a length d9. A shoulder 120a may be arranged between the base portion 116a and the tip portion 118a of first teeth 110a. Second teeth 110b may also have a base portion 116b extending from the head portion 102 and may have a length d10. Second teeth 110b may include a tip portion 118b with a length d11. The tip portion 118b and the base portion 116b may be separated by a shoulder 120b.

In this embodiment, the total length of first teeth 110a (e.g., d8+d9) may be greater than that of second teeth 110b. In this regard, both the length d9 of the tip portion 118a and the length d8 of the base portion 116a may be longer than the length d11 of the tip portion 118b and the length d10 of the base portion 116b of second teeth 110b, respectively.

As discussed above, first teeth 110a and second teeth 110b of the undercoat rake 124 may be alternately disposed along the length of the head portion 102 such that two first teeth 110a repeat, followed by alternating first teeth 110a and second teeth 110b. First teeth 110a and second teeth 110b may alternate in any manner.

Any of the forgoing embodiments of an undercoat rake may be used in a method of grooming a furred animal. The method may include a user grasping the handle portion of an undercoat rake and placing the undercoat rake adjacent to a furred animal such that grooming teeth affixed to the head portion are generally disposed within the animal's fur. The undercoat rake may then be moved along the furred animal's body such that the grooming teeth remain in contact with the animal's fur such that the animal's fur passes between the grooming teeth. In turn, as the animal's fur passes between the grooming teeth of the undercoat rake, loose hair or soon to be shed hair may be removed from the animal's fur.

In sum, the foregoing embodiments presented may include grooming teeth operatively affixed to a rake body. The grooming teeth may include a base portion and a tip portion separated by a shoulder. The grooming teeth may have different tip portion lengths such that some grooming teeth have a longer tip portion than other grooming teeth (e.g., have a different grooming depth profile). As such, a variable depth grooming profile along the rake body may be presented when grooming a furred animal. The undercoat rakes presented herein may be generally advantageous for grooming of furred animals due, at least in part, to the variable depth grooming profiles of the grooming teeth as it has been found that the variable depth grooming profiles may facilitate improved undercoat fur removal.

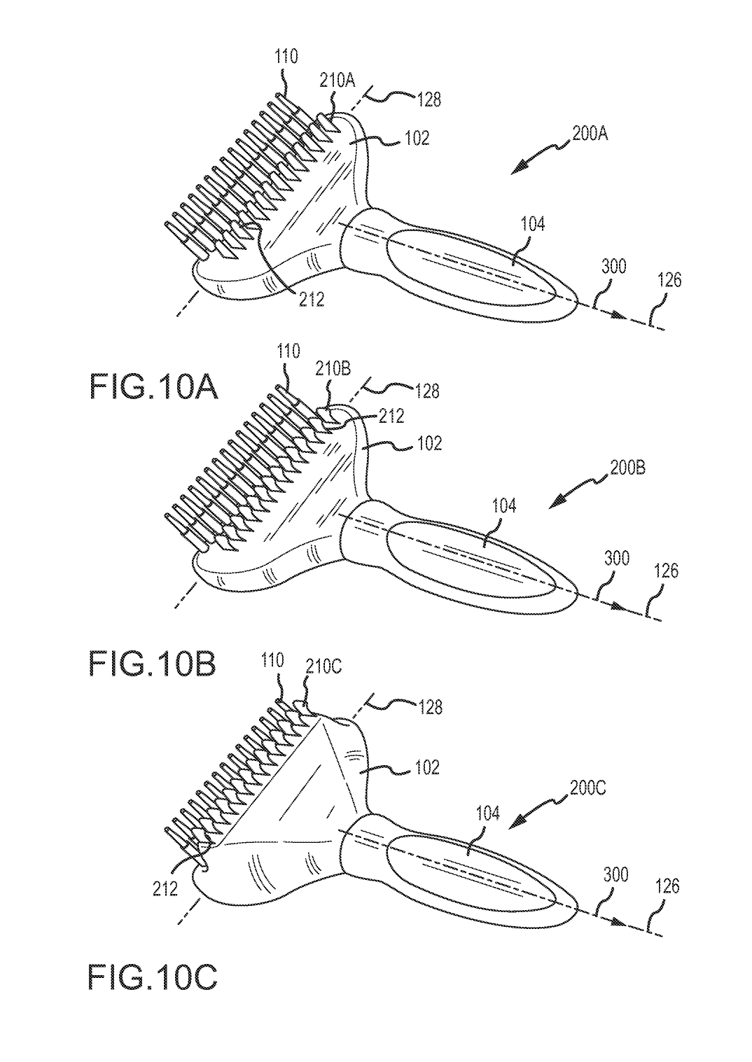

Moreover, a hybrid grooming tool 200 may be provided that includes a plurality of grooming teeth 110 and a plurality of de-shedding blades 210 such as the grooming tools 200A-200C depicted in FIGS. 10A-10C. In this regard, the hybrid grooming tools described herein may be of a generally similar construction as any of the undercoat rakes described above. In this regard, the hybrid grooming tool 200 may include grooming teeth and/or tool body configurations according to any of the aspects or embodiments described above. Furthermore, the grooming teeth of a hybrid grooming tool may comprise teeth different from those described above. For example, grooming teeth without a base portion and tip portion (i.e., continuous, un-stepped grooming teeth) may be provided. Such continuous teeth may be substantially cylindrical, rectangular, frustoconical, or any other appropriate shape.

Additionally, a hybrid grooming tool 200 may be provided with a plurality of de-shedding blades 210. The de-shedding blades 210 may be provided on the hybrid grooming tool 200 such that the hybrid grooming tool 200 may be disposed adjacent to a furred animal such that both the de-shedding blades 210 and the grooming teeth 110 may be disposed in the fur of the animal. In turn, when the hybrid grooming tool 200 is moved with respect to the animal, both the grooming teeth 110 and the de-shedding blades 210 may be passed through the fur of the animal. Each of the de-shedding blades 210 may include blade edges that are disposed with respect to the grooming teeth 110 such that when the hybrid grooming tool 200 (i.e., the de-shedding blades 210 and grooming teeth 110 thereof) are passed through the fur of the animal, both the de-shedding blades 210 and the grooming teeth 110 contact the fur of the animal. Accordingly, the grooming teeth 110 may remove loose fur from the coat of the furred animal as described above, and the de-shedding blades 210 of the hybrid grooming tool 200 may contact and cut through any matted or tangled fur as the hybrid grooming tool 200 is moved with respect to the animal. As the blade edges of the de-shedding blades 210 may contact and pass through the matted fur, the matted fur may be cut into smaller portions such that the matted fur may be more easily removed or untangled. Also, because blade edges may contact the matted fur, the matted fur may not be pulled, but rather the de-shedding blades may cut through the matted fur, thus, stripping out tangled fur and cutting the matted fur into more easily removed portions allowing for easier, less painful removal of the matted portions of fur.

For example, as shown in the embodiments of the hybrid grooming tools 200A-200C depicted in FIGS. 10A-10C, the blade edges 212 of the de-shedding blades 210 may be offset from the grooming teeth 110. The blade edges 212 of the de-shedding blades 210 may be offset from the grooming teeth 110 in a direction corresponding to the longitudinal axis 126 of the handle portion 104 (e.g., a direction perpendicular to the major axis 128 of the head portion 102). For example, the hybrid grooming tools 200 may be moved with respect to the furred animal in a direction 300 corresponding with the direction in which the handle portion 104 extends from a head portion 102. In this regard, the blade edges 212 of the de-shedding blades 210 may be upstream of the grooming teeth 110 as the hybrid grooming tool 200 may be passed through the fur of the furred animal (i.e., so that the de-shedding blades may cut matted portions of fur and the grooming teeth may remove any loose fur from the coat of the animal). Accordingly, in the event that a matted portion of fur may be encountered by the hybrid grooming tool 200, the de-shedding blades 210 may contact and cut though the matted portion of fur prior to the grooming teeth 110 passing through the matted portion of fur. As such, rather than having to stop grooming using the grooming teeth 110 to cut out matted portions of fur, the hybrid grooming tool 200 may be used to help to cut through, and break up, the matted portion of fur.

The de-shedding blades 210 may be constructed of wood, polymer, metal, any other suitable material, or a combination thereof. By suitable material, it is to be understood that the material from which the de-shedding blades 210 are constructed may be substantially rigid and may be capable of being sharpened into a blade edge. In one embodiment, the de-shedding blades 210 may be metallic. By way of example, the de-shedding blades 210 may be constructed from a rust and corrosion resistant material such as stainless steel.

The blade edges 212 of the de-shedding blades 210 may be offset from the grooming teeth 110 by a distance of not less than about 2 mm and not greater than about 8 mm. More preferably, the blade edges 212 of the de-shedding blades 210 may be offset from the grooming teeth 110 by a distance of not less than about 3 mm and not greater than about 5 mm. Additionally, the de-shedding blades 210 may be spaced apart along a length corresponding to the major axis 128 of the head portion 102 by a distance corresponding to the spacing of the grooming teeth 110 as described above (e.g., corresponding to dimension d12 or about 3-8 mm).

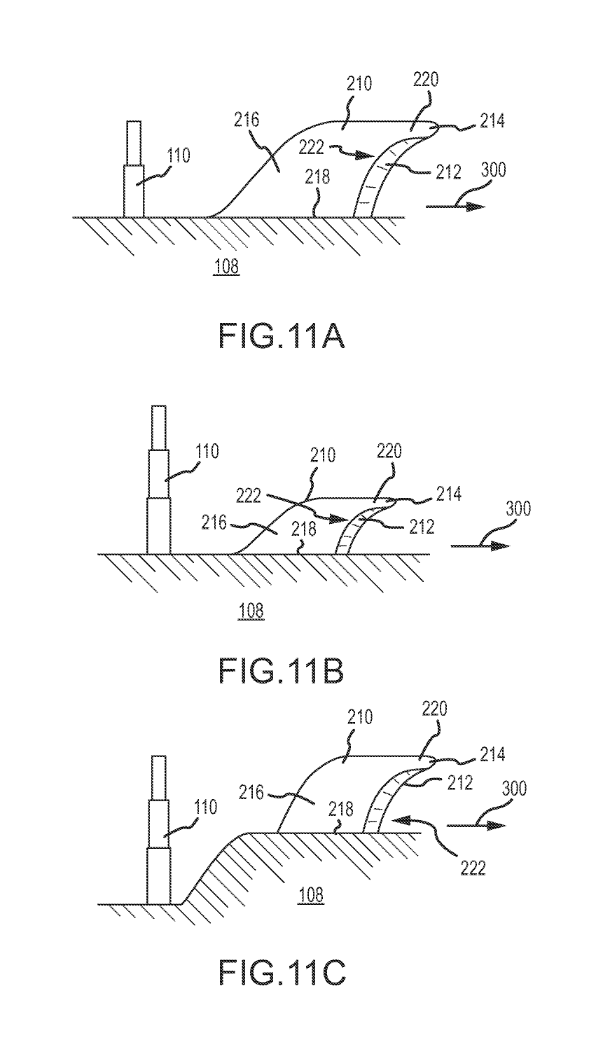

The embodiment of the grooming tool 200A depicted in FIG. 10A may include standard de-shedding blades 210A with blade edges 212 offset from the grooming teeth 110 in a direction along the direction of travel 300 of the grooming tool 200A through the fur of the animal. In contrast, the grooming tools 200B and 200C depicted in FIG. 10B and FIG. 100, respectively, include safety de-shedding blades 210B and 210C. That is, the de-shedding blades 210B and 210C may include a rounded or dull end portion of the blade edge 212 so that the blade edge 212 of the blades 210B and 210C do not include a point at the distal end of the blade edge 212 as will be discussed in greater detail below with respect to FIGS. 11A-11C. In this regard, the blade edge 212 of the de-shedding blades 210B and 210C may be at least partially shielded to help prevent inadvertent contact with the blade edge 212. In this regard, the blade edge 212 may only be exposed to objects impinging on the de-shedding blades 210B and 210C that are traveling substantially parallel to the major axis 126 of the handle portion 104 (i.e. perpendicular to a major axis 128 of the head portion 102). This may reduce the likelihood that the de-shedding blades 210B and 210C come into contact with, for example, the skin of the animal or the skin of a groomer.

As can be further appreciated from FIGS. 11A-11C, as briefly described above, the blade edges 212 of the de-shedding blades 210 may be upstream of the grooming teeth 110 with respect to the direction of travel 300 of the hybrid grooming tool with respect to the furred animal. As such, the blade edge 212 may be provided on a side of the de-shedding blade 210 opposite the grooming teeth 110. As can be appreciated, when the grooming teeth 110 and the de-shedding blades 210 are passed through the fur of the animal in the direction of travel 300, the blade edges 212 may come into contact with fur (e.g., matted fur) prior to the grooming teeth 110, thus, the blade edges 212 may be upstream of the grooming teeth 100, for example, closer to the handle portion 104.

With further reference to FIGS. 11A-11C, side views of the grooming teeth 110 and de-shedding blades 210 of several embodiments of hybrid grooming tools are shown. FIGS. 11A-11C illustrate side views of various embodiments of de-shedding blades 210. Each of the depicted de-shedding blades 210 may include a substantially planar body 216 having a bottom edge 218 adjacent to the rake body 108. The de-shedding blade 210 may also have a hooked fur-engaging member 220 extending from the bottom edge 218. A sharpened curvilinear portion 222 may be disposed between the bottom edge 218 and the fur-engaging member 220 defining a blade edge 212 The blade edge 212 may be generally sharper (i.e., thinner at the edge) than the other portions of the planar body 216, including the fur-engaging member 220. Such a structure may be advantageous for removing loose fur from an animal, such as for removing the loose undercoat from a dog or for removing loose fur from a horse or other domestic animals. In this regard, a blade edge 212 may extend along at least a portion of at least one edge of the planar body 216 of the de-shedding blade 210. The distal end 214 of the blade edge 212 may dull (i.e. relatively thicker than the blade edge 212). As such, structures (e.g., the skin of the animal) coming into contact with only the distal end 214 of the blade edge may not be cut.

In FIG. 11A, the de-shedding blades 210 may extend from the rake body 108 substantially the same distance as the grooming teeth 110. As shown in another embodiment depicted in FIG. 11B, the de-shedding blades 210 may extend for only a portion of the distance that the grooming teeth 110 extend from the rake body 108. Further still, as shown in FIG. 11C, the de-shedding blades 210 may extend for a distance corresponding with only a portion of the length of the grooming teeth 110, however, the distal end of the grooming teeth 110 and the distal end 214 of the de-shedding blades 210 may be at substantially the same elevation. In this regard, the rake body 108 may be stepped such that the bottom edge 218 may be at an elevation different than that of the proximal portion of the grooming teeth 110. A similar configuration is depicted in FIG. 10C, wherein a stepped head portion 102 is provided. Additionally, while not shown, de-shedding blades may be provided that extend for a greater distance from the rake body than the grooming teeth. In any event, it may be preferred that the de-shedding blades 210 are at an elevation that is equal to or less than the elevation of the distal end of the grooming teeth 110. In this regard, the de-shedding blades 210 may extend from the rake body 108 by distances corresponding to the distances the grooming teeth 110 may extend from the rake body 108 as described above (e.g., about 10 mm to about 40 mm). Furthermore, in the case where the de-shedding blades 210 only extend for a portion of the distance the grooming teeth 110 extend from the rake body 108, the de-shedding blades 210 may only extend no more than about 40%, 50%, 60%, or even 70% of the distance the grooming teeth 110 extend from the rake body.

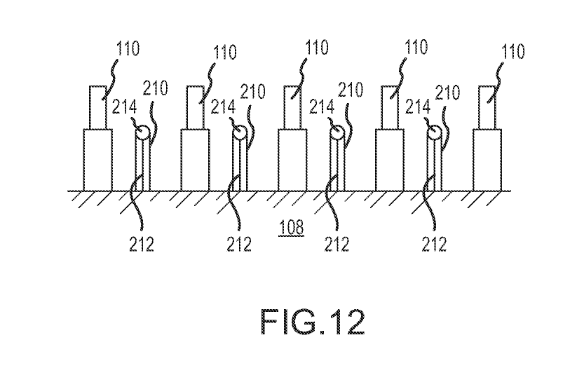

FIG. 12 depicts an end view of a plurality of grooming teeth 110 and de-shedding blades 210 of a hybrid grooming tool. For example, the view in FIG. 12 may be taken along the longitudinal axis 126 of the handle portion 104 toward the head portion 102. As can be appreciated in FIG. 12, the de-shedding blades 210 may be provided between adjacent grooming teeth 110 in a direction along the row of the grooming teeth 110. In this regard, while the de-shedding blades 210 may be offset from the grooming teeth 110 with respect to a direction corresponding to the longitudinal axis 126 of the handle portion 104 (as shown in FIGS. 10A-10C), the de-shedding blades 210 may also be offset from the grooming teeth 110 along the direction corresponding to the major axis 128 of the head portion 102. A de-shedding blade 210 may be positioned between each adjacent pair of grooming teeth 110. Alternatively, additional or fewer de-shedding blades may be provided. For example, a de-shedding blade 210 may be provided between every other adjacent pair of grooming teeth 110. Furthermore, more than one de-shedding blade 210 may be provided between adjacent pairs of grooming teeth 110. In another embodiment, the de-shedding blades 210 may be aligned with the grooming teeth 110 with respect to a direction along the major axis 128 of the head portion 102.

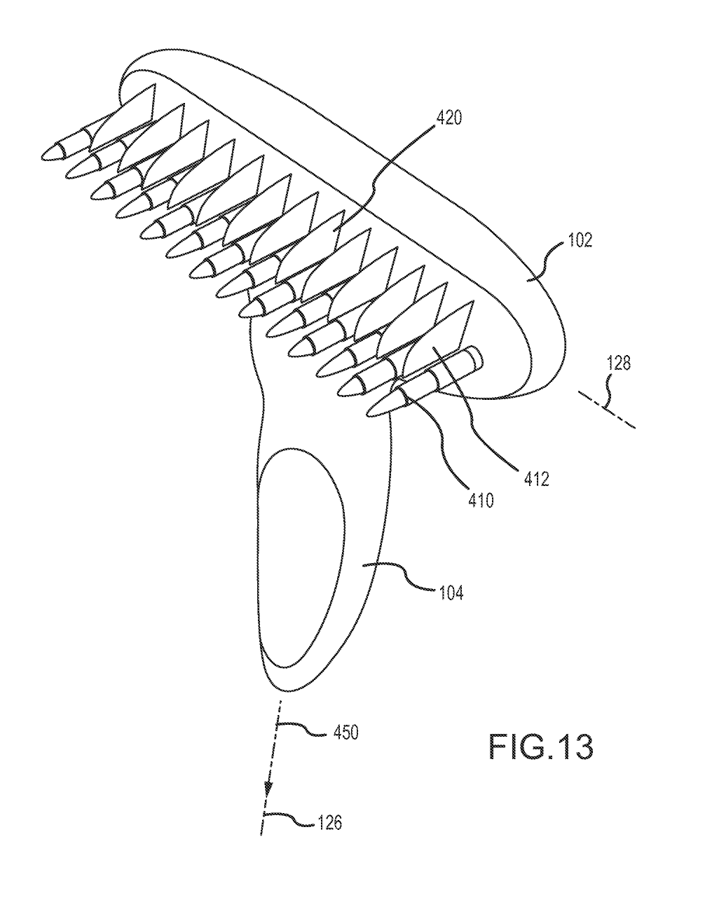

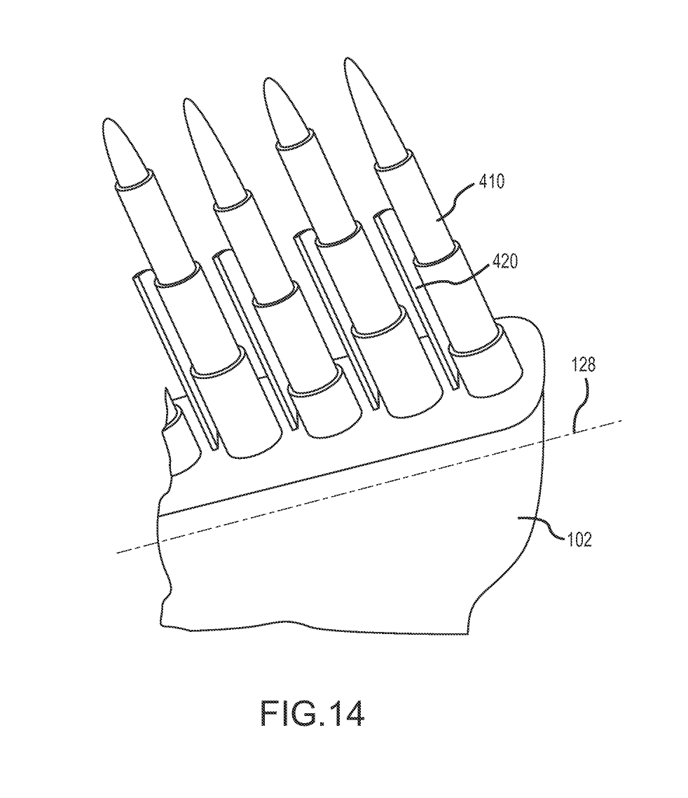

FIGS. 13 and 14 depict an alternative embodiment of a hybrid grooming tool 400. The hybrid grooming tool 400 includes a plurality of de-shedding blades 420 offset from a plurality of grooming teeth 410 such that the blade edges 412 of the de-shedding blades 420 are downstream of the grooming teeth 410 as the hybrid grooming tool 400 is moved in direction 450 corresponding to a direction along the direction of the major axis 126 of the handle portion 104. In this regard, as the hybrid grooming tool 400 is passed in direction 450 through the fur of the animal, the grooming teeth 410 may pass through the fur ahead of the blade edges 412 of the de-shedding blades 420. With respect to FIG. 14, it will be appreciated that the de-shedding blades 420 may be positioned between adjacent grooming teeth 410 along a length corresponding to the major axis 128 of the head portion 102.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A hybrid grooming tool for grooming a furred animal, the hybrid grooming tool comprising:
a tool body;
a plurality of grooming teeth operatively affixed to and extending from the tool body; and
a plurality of de-shedding blades operatively affixed to and extending from the tool body;
wherein the tool body is disposable adjacent to fur of the furred animal such that the plurality of grooming teeth and the plurality of de-shedding blades are both disposed within the fur of the furred animal.

2. The hybrid grooming tool of claim 1, wherein the plurality of grooming teeth and the plurality of de-shedding blades extend in substantially the same direction from the tool body.

3. The hybrid grooming tool of claim 2, wherein the plurality of de-shedding blades comprise safety blades.

4. The hybrid grooming tool of claim 3, wherein the safety blades comprise a dull distal end portion of a blade edge extending along at least one edge of the de-shedding blade.

5. The hybrid grooming tool of claim 4, wherein the tool body comprises at least a head portion having a length along a major axis of the head portion, and wherein the grooming teeth are affixed to the tool body along the length of the head portion in a first row and the de-shedding blades are affixed to the tool body along the length of the head portion in a second row.

6. The hybrid grooming tool of claim 5, wherein the blade edge is offset by a distance perpendicular to the major axis of the head portion with respect to the grooming teeth.

7. The hybrid grooming tool of claim 6, wherein the blade edge is offset from the grooming teeth by at least about 2 mm and not greater than about 8 mm.

8. The hybrid grooming tool of claim 6, wherein the grooming teeth comprise:
a plurality of first teeth, the first teeth having a base portion adjacent to and extending from the tool body, a tip portion at a distal end, and a shoulder disposed between the base portion and the tip portion, and
a plurality of second teeth, the second teeth having a base portion adjacent to and extending from the tool body, a tip portion at a distal end, and a shoulder disposed between the base portion and the tip portion;
wherein the length of the tip portion of the first teeth is greater than the length of the tip portion of the second teeth.

9. The hybrid grooming tool of claim 8, wherein the first teeth and the second teeth are alternately disposed along at least a portion of the length of the head portion.

10. The hybrid grooming tool of claim 9, wherein at least one of the plurality of safety blades is disposed, with respect to the length along the major axis of the head portion, between adjacent grooming teeth.

11. The hybrid grooming tool of claim 10, wherein the first teeth and the second teeth alternate at adjacent tooth positions along at least a portion of the length of the head portion.

12. The hybrid grooming tool of claim 11, wherein adjacent grooming teeth are spaced apart by at least about 2 mm and not greater than about 6 mm.

13. The hybrid grooming tool of claim 12, wherein at least one of the second teeth is disposed adjacent to two of the first teeth.

14. The hybrid grooming tool of claim 8, wherein the total length of the first teeth and the total length of the second teeth are substantially the same.

15. The hybrid grooming tool of claim 14, wherein the total length of the first teeth and the total length of the second teeth is at least about 10 mm and not greater than about 40 mm.

16. The hybrid grooming tool of claim 8, wherein the total length of the first teeth and the total length of the second teeth are different.

17. The hybrid grooming tool of claim 8, wherein the tip portion of the first teeth is at least 15% longer than the tip portion of the second teeth.

18. The hybrid grooming tool of claim 17, wherein the length of the tip portion of the first teeth is at least about 5 mm and the length of the tip portion of the second teeth is not greater than about 30 mm.

19. The hybrid grooming tool of claim 8, wherein the base portions of the grooming teeth have a cross dimension that is at least about 2 mm and not greater than about 6 mm.

20. The hybrid grooming tool of claim 19, wherein the tip portion of the grooming teeth have a cross dimension that is at least about 0.5 mm and not greater than about 4 mm.

21. The hybrid grooming tool of claim 1, wherein the grooming teeth are substantially rigid.

22. The hybrid grooming tool of claim 1, wherein the grooming teeth are metallic.

23. The hybrid grooming tool of claim 23, wherein the grooming teeth are stainless steel.

24. The hybrid grooming tool of claim 1, wherein the de-shedding blades are metallic.

25. The hybrid grooming tool of claim 24, wherein the de-shedding blades are stainless steel.

26. The hybrid grooming tool of claim 1, wherein the tool body further comprises a handle portion that is adapted to be gripped by a user.

27. The hybrid grooming tool of claim 26, wherein the major axis of the head portion is substantially perpendicular to a longitudinal axis of the handle portion.

28. The hybrid grooming tool of claim 27, wherein the handle portion extends from the head portion in a direction corresponding to a direction of travel of the hybrid grooming tool with respect to the furred animal.

29. The hybrid grooming tool according to claim 28, wherein a blade edge of the plurality of de-shedding blades is positioned upstream with respect to the plurality of grooming teeth along the direction of travel of the hybrid grooming tool with respect to the furred animal.

30. The hybrid grooming tool according to claim 29, wherein the blade edge is provided opposite the grooming teeth with respect to the direction of travel of the hybrid grooming tool with respect to the furred animal.

31. The hybrid grooming tool according to claim 1, wherein the de-shedding blades extend away from the tool body for a portion of the distance which the plurality of grooming teeth extend from the tool body.

32. The hybrid grooming tool according to claim 31, wherein the de-shedding blades extend from the tool body for no more than 70% of the distance which the plurality of grooming teeth extend from the tool body.

33. The hybrid grooming tool according to claim 30, wherein the de-shedding blades extend along substantially the entire distance which the plurality of grooming teeth extend from the tool body.

34. A hybrid grooming tool for grooming a furred animal, the hybrid grooming tool comprising:
a tool body comprising a head portion having a length along a major axis of the head portion and a handle portion having a longitudinal axis, the major axis being substantially perpendicular to the longitudinal axis;
a plurality of grooming teeth operatively affixed to the head portion in a first row, the grooming teeth comprising:
a plurality of first teeth, the first teeth having a base portion adjacent to and extending from the tool body, a tip portion at a distal end, and a shoulder disposed between the base portion and the tip portion, and
a plurality of second teeth alternately disposed with the first teeth along the length of the head portion, the second teeth having a base portion adjacent to and extending from the tool body, a tip portion at a distal end, and a shoulder disposed between the base portion and the tip portion,
wherein the length of the tip portion of the first teeth is greater than the length of the tip portion of the second teeth and wherein the total length of the first teeth and the total length of the second teeth are substantially the same; and
a plurality of de-shedding blades operatively affixed to the head portion in a second row and extending therefrom in substantially the same direction from the head portion as the plurality of grooming teeth, the de-shedding blades including a blade edge along at least one edge thereof;
wherein the blade edges of the de-shedding blades are offset from the grooming teeth with respect to a direction corresponding to the longitudinal axis of the handle portion.

35. A method for grooming a furred animal, the method comprising:
providing a hybrid grooming tool according to claim 1;
positioning the hybrid grooming tool adjacent to the furred animal such that the grooming teeth and de-shedding blades engage fur of the furred animal; and
moving the hybrid grooming tool with respect to the furred animal while maintaining engagement of the grooming teeth and de-shedding blades with the fur such that the grooming teeth act upon the fur passing therebetween to remove loose hairs therefrom and the de-shedding blades cut through matted fur contacting the de-shedding blades, thus grooming the animal.

36. The method according to claim 35, wherein the de-shedding blades cut through matted fur prior to the grooming teeth passing through the matted fur.
